(19) United States
(12) Patent Application Publication
(10) Pub. No.: US 2011/0280178 A1
(43) Pub. Date: Nov. 17, 2011

(54) Method and System for Providing Emergency Communications via Satellite

(75) Inventor: Greg Heifner, Columbia, MO (US)

(73) Assignee: ODN, Inc., Columbia, MO (US)

(21) Appl. No.: 12/778,690

(22) Filed: May 12, 2010

(51) Int. Cl. H04B 7/204; H04B 7/185

(52) U.S. Cl. 370/325; 370/316

(57) ABSTRACT

Described herein is a system and method for using a satellite mesh network to provide backup for a land-based communication network. According to various embodiments, the system includes a failover device for detecting the outage of the land-based network and switching the communications from the land-based network to the satellite mesh network. In addition, the failover device provides synchronizations that are required by the communications between the land-based network routers. The system further includes a satellite-based network router and protocols for routing the communications through the satellite-based network, when the network traffic is switched onto the satellite network.

### TECHNICAL FIELD

The present invention relates in general to the field of telecommunications and in particular to satellite communications.

### BACKGROUND OF THE INVENTION

The ability to provide uninterrupted connections is desirable in many situations. For instance, it is critical for public safety agencies or first responders to emergencies or natural disasters to keep communications running. On-scene personnel must have constant access to voice, data and radio communications, even when local land-based network services are down. In addition, government agencies need to be able to communicate with each other, and to have a coordinated response to emergency situations. Most government agencies use communications networks that rely on land based facilities (in whole or part) and their coordination is disrupted if those land based facilities are compromised. Other situations where reliable emergency telecommunications and network services are desirable include cell phone companies, large scale public activities, companies or organizations with large vehicle fleets and numerous field staffs and/or multiple offices.

Land Mobile Radio Systems (LMRSs) are widely used to provide communications and data access to personnel in the field. The most common users of LMRS are police, fire, emergency medical services and other first responders. An LMRS typically has a central “hub” location and multiple remote sites (jointly and severally the “LMRS Sites”). Radio transmitters and receivers are typically installed on antenna towers at the LMRS Sites and provide communications links to radios in the field. LMRS Sites typically communicate with each other using landline telephone circuits based on T-1 (the “T-1 Landline”) provided by local telephone carriers (“T-1 Carriers”).¹ While standard telephone lines can transfer data and voice at a rate of about 30,000 bits per second (i.e., 30 kbps) using a dial-up modem, a T1 line can transmit 1.544 megabits per second each way, or can be used to transmit 24 digitized voice channels. In essence a T-1 line includes 24 telephone circuits bundled together to supply a data connection. This use of T-1 Landlines between LMRS Sites is commonly known as the “backhaul” or “trunking” of LMRS communications traffic. ¹ This can be either a whole or partial T-1 circuit.

The LMRS typically includes a router (the “LMRS Router”) located at each LMRS Site that enables LMRS radio traffic to be transmitted over the T-1 Landline using conventional T-1 communications protocols, e.g. ESF T1. T-1 Landlines (or the equipment that supports a T-1 Landline) can be compromised or disabled in an emergency or disaster that damages the telephone companies ground based infrastructure. For instance, during hurricanes Katrina and Rita in 2005, critical LMRS voice and data communications in several states were offline due to damage to the facilities of T-1 Carriers at a time when emergency communications were needed most. LMRS Sites could not communicate with each other in those states because their terrestrial based connections to remote tower sites and other locations, as provided by T-1 Landlines, were cut off. Most emergency planners understand the importance of having a truly independent means of communications that is immune to the kind of damage land-based communication networks can suffer in an emergency or disaster.

Cellular telephones are widely used by individuals, businesses and government to provide mobile voice and data communications. A cellular telephone network is typically configured like an LMRS network with a central “hub” location and multiple remote sites (jointly and severally the “Cell Phone Sites”). Radio transmitters and receivers are installed on antenna towers or arrays at the Cell Phone Sites and provide communications links to cell phones in the field. Like LMRS Sites, Cell Phone Sites typically communicate back to a central network operations center using T-1 Landlines for the “backhaul” of communications traffic.

Similar to LMRS Routers, the cell phone network includes a router (the “Cell Phone Router”) located at each Cell Phone Site that enables cell phone traffic to be carried over a T-1 Landline using conventional T-1 communications protocols, e.g. ESF T1. The same emergencies or disasters that interrupt the T-1 Landlines (or the equipment that supports the T-1 Landline) used by LMRS can also interrupt the T-1 Landlines used by cell phone carriers. Both cell phone and LMRS communications were interrupted during hurricanes Katrina and Rita due to damage to the facilities of T-1 Carriers.

As a result, there is a need for a communications system that can quickly and efficiently replace a lost or damaged T-1 Landline for LMRS networks, cell phone networks and other similar networks that rely on T-1 telephone circuits for the “backhaul” of communications traffic (the “T-1 Backhaul Networks”).

Satellites can provide uninterrupted and reliable communications anywhere independent of land-based assets. Satellite systems continue to operate when the terrestrial T-1 Landlines are interrupted due to damage to the infrastructure of the telephone carrier or other causes. Thus satellite systems can provide the “backhaul” of communications traffic required by T-1 Backhaul Networks when T-1 Landlines are compromised. The basic components of a satellite communications system include the communications satellite, which is usually in geosynchronous orbit over the Equator, and a Very Small Aperture Terminal (VSAT), which is a two-way ground station with a dish antenna. The VSATs access the satellites by transmitting and receiving data to and from the satellites and a Network Operations Center at the satellite teleport (HUB).

Satellite communications networks that serve multiple sites typically have a “hub and spoke” configuration. The hub acts as the central point for receiving and transmitting data. (The data can include voice, video, other information and LMRS radio communications). The spokes are located at the remote sites and communicate only with the hub. A hub and spoke configuration is unable to effectively replace T-1 Landlines for T-1 Backhaul Networks due to substantial latency. Latency is the delay between the time a transmission is made at a transmitter and the time received at the receiver. The latency of a T-1 Landline is typically 4 milliseconds (“ms”) to 40 ms. The latency for one “spoke” to communicate with another “spoke” is over one (1) second because the signal has to be transmitted from the first spoke to the hub and then from the hub to the next spoke. This includes two (2) round trips to the satellite. This latency seriously degrades applications that depend on low latency rates such as the voice over Internet protocol (VoIP) or radio over Internet (RoIP).

### BRIEF SUMMARY OF THE INVENTION

Described herein is a system and method for using a satellite-based mesh transmission system to provide automated backup connections for land-based communications.

In some embodiments, a system is provided, including a failover device connected to a land-based network router for detecting a network failure in a synchronized land-based network that provides communications between the land-based network and a remote station, automatically switching the communication from the land-based network to a satellite-based network in response to the network failure in the synchronized land-based network, and providing synchronization of the systems over the satellite-based network.

The system also includes a satellite-based network modem/router connected to the failover device for routing the communications to and from the remote station through the satellite-based network.

According to some alternative embodiments, a method is provided, including performing communications over a land-based network between first and second stations, wherein the communications require network synchronizations between the first and second stations, detecting a network failure in the land-based network, and automatically switching the communications to a satellite-based network, wherein the network synchronizations are provided by allowing all synchronization signals for the system to be communicated by the satellite-based network.

According to still some alternative embodiments, a method is provided, including detecting a network failure in a synchronized land-based network providing communications between first and second land-based network routers that require synchronizations, automatically switching communications to an IP-based satellite network and providing the synchronizations required by the first and second land-based network routers for the communications over the IP-based satellite network so that the first and second land-based network routers are unaware of the switching from the synchronized land-based network to the IP-based satellite network. No human intervention is required to switch the communications from the land-based network to the satellite network.

According to still some further embodiments, the system is adapted to provide emergency and non-emergency communications for T-1 backhaul networks, including without limitation, LMRS and cell phone networks by replacing a T-1 landline with a satellite mesh circuit. In an emergency situation, where the T-1 backhaul networks are usually damage or fail, first responders to the situation need a reliable backup and emergency communications system to ensure critical communications always stay online and to enable coordination with other agencies and support personnel. According to these embodiments, the satellite-based network is independent from the terrestrial T-1 networks while providing interoperability and connection to the public switched telephone network (“PSTN”) and the T-1 backhaul router. In addition, the system can seamlessly and automatically switch the communications from the T-1 land-based networks to the satellite mesh network, so that the communications between the T-1 routers are carried on through the satellite mesh network without the necessity of human interventions.

### BRIEF DESCRIPTION OF THE SEVERAL VIEWS OF THE DRAWING

FIG. 1 depicts the diagram of a system according to various embodiments for using a satellite mesh network to provide backup connections; and

FIG. 2 depicts a method according to various embodiments for using a satellite mesh network to provide backup connections for land-based communications.

### DETAILED DESCRIPTION OF THE INVENTION

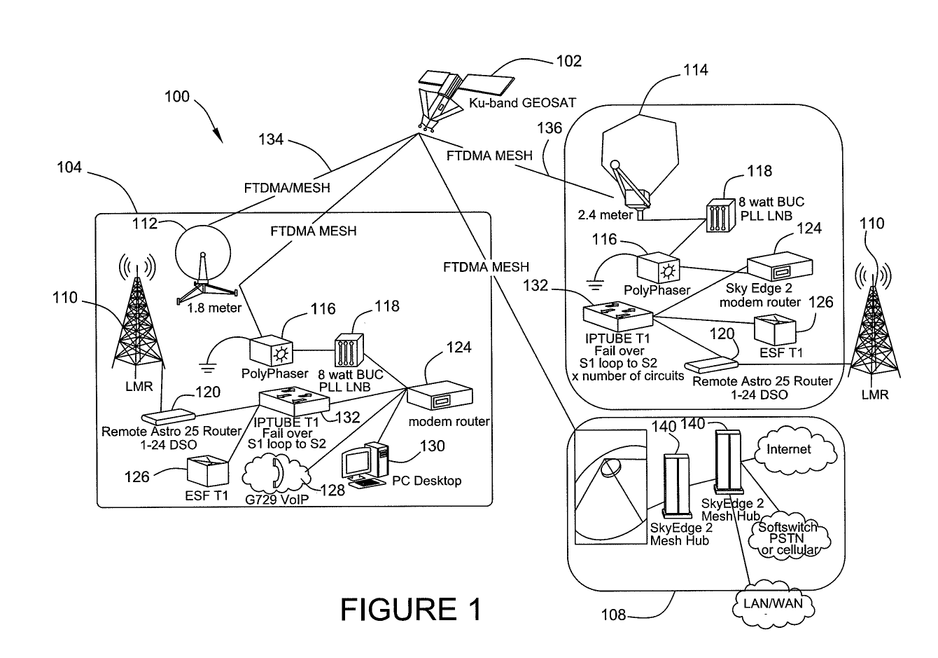

Now turning to the drawings and referring to FIG. 1, a diagram of satellite mesh network 100 is depicted therein. In a satellite mesh circuit such as network 100, communications between any two ground stations (e.g., stations 104 and 106) are transmitted directly to each other through satellite 102, without the necessity of travelling through a central hub, such as hub 108. Compared with the conventional “hub-and-spoke” satellite networks, system 100 reduces the latency of satellite communications in half and makes it possible for mesh satellite circuits to replace T-1 landlines.

In general, there are two types of satellites for creating the satellite mesh network 100. The first is commonly known as regenerative satellite which carries a space hardened router onboard the satellite. This allows traffic to be routed onboard the satellite itself. The other is known as a transparent satellite which relies on ground based equipment to create satellite mesh circuits. Although both types of satellites can be used for satellite 102 as depicted in FIG. 1, one skilled in the art will appreciate that a network based on the transparent satellite is more cost effective than that based on the regenerative satellite, because the former does not require proprietary technologies to be onboard the satellite, thereby reducing the costs associated with manufacturing, launching, and maintaining the satellite.

As further depicted in FIG. 1, in addition to the satellite mesh network, system 100 further provides equipment that connects the existing routers of a T-1 backhaul network through the satellite mesh circuit (or network), communications protocols that enable the T-1 backhaul routers to communicate with each other immediately, seamlessly and without on-site intervention over the satellite mesh circuit when the T-1 landlines are disrupted due to network failures, and communications protocols that enable a technician or service personnel to get remote access over the internet to the network equipment and the protocols to manage, trouble shoot, maintain and change equipment and configurations.

Specifically, system 100 includes satellite-based network router 124, which acts as a gateway to the satellite mesh circuit, failover device 132, which acts a bridge between the satellite mesh circuit and the T-1 network, and land-based network router 120, which connects the LMR radio system to the T-1 landline network and is therefore the gateway to the T-1 landline.

All of these can be off-the-shelf components made by other vendors or proprietary components made by a specific vendor. For example, the failover device 132 can be the DLT-1 provided by Engage Communication, Inc. and ordered with a firmware download that supports this invention. The satellite-based network router 124 can be the SkyEdge 2 modem/router provided by Gilat Satellite Networks Ltd. The land-based network router 120 can be any T-1 backhaul router such as the Astro25 Core Router and Edge Routers provided by Motorola, Inc.

As depicted in FIG. 1, the land-based network router 120 produces data in a format that can be transmitted from station 104 to another land-based network router 120 in station 106 over a land-based network such as a T-1 network. In general the land-based network router 120 provides communications such as voice or data services that require synchronizations between the stations 104 and 106. For example, the land-based network router 120 is connected to an LMR system that provides radio communications between a base station (e.g., the station 106) and a remote station (e.g., the station 104). The land-based network router 120 receives voice and data signals from radio tower 110 and converts the signals into a data format (e.g., data packets) suitable for transmission over the T1 landline (e.g., ESF T1 126).

In order to provide backup communications to the land-based network router 120, the failover device 132 is connected between land-based network router 120 and the T-1 landline 126. During normal operation, the failover device 132 collects the data from the land-based network router 120 and forwards them onto the T-1 landline 126. In addition, the failover device 132 monitors the T-1 landline. When the T-1 landline is disrupted due to network a failure, the failover device 132 automatically detects the outage, continues to collect the T-1 data output of the Astro 25 Router and then changes the data into an Internet Protocol format (e.g., IP packets).

The satellite-based network router 124, which is connected to the failover device 132, takes the IP packets sent by the failover device 132, transmits them over the satellite mesh circuit to the satellite-based network router 124 in a remote station (e.g., the station 106), which than passes the IP packets to the failover device 132 at the remote station, which then converts them back to a T-1 compatible format and sends them to the land-based network router 120 at the remote station, while retaining system synchronization.

According to a further embodiment as shown in FIG. 1, the land-based network router 124 is connected to a radio network such as an LMR system 110 for providing voice and data communications between remote stations 104 and 106 and additionally providing the stations with access to Internet, public switch telephone network (PSTN), and local or wide area network (LAN/WAN). The communications between stations 104 and 106 require system synchronization, which takes into account the protocols and latencies (4 ms to 40 ms) of the T-1 landline which is the primary connection between the routers. The satellite-based network based on IP packets, however, does not provide the same protocols and latency as a T-1 landline. Utilizing the technology described, this necessary synchronization between routers (including adjustments for latency) can be imbedded in the IP stream using this technique, thus retaining full synchronization between routers when failed over from a T-1 landline to satellite.

In order to allow the land-based network routers 120 in stations 104 and 106 to communicate with each other over the satellite-based network, the failover device 132 is programmed to provide the synchronization capability, including adjustments for latency. For example, when the failover device 132 at station 104 detects that the T-1 landline is down, it continues to collect the data from the land-base network router 120 and converts the data into IP packets that are suitable for transmissions over the satellite-based network. In addition, the failover device 132 incorporates synchronization signals into the IP packets, according to the settings configured therein and the programs running thereon.

In particular, the failover device 132 encapsulates into the IP packets the T-1 framing and signaling bits, which are required to support LMR features such as call conferencing, call forwarding, and caller ID. The failover device 132 also encapsulates the adjustments necessary for the routers to remain synchronized notwithstanding a change for a low latency T-1 landline to a higher latency satellite circuit. As a result, when the T-1 landline is down due to network failures, the communications between the land-based network routers 120 are automatically switched to the satellite-based network, where the synchronizations between the routers are maintained through the failover devices 132. No modifications or human interventions are necessary for the land-based network routers 120 in order to carry on the communications over the satellite-based network. From the perspective of the land-based network routers 120, the communications are never interrupted as if the T-1 landline is still operational.

In addition, the failover device 132 has a T-1 interface that connects directly to the T-1 landline and an IP network interface that connects to IP network equipment such as the satellite-based network router 124.

According to a further embodiment, the failover device 132 has an interface that allows communications with a computer console for managing and configuring the device. Management and configuration of the failover device 132 can be accomplished with a command line interface session that is accessed through any standard computer as well known in the art.

According to another embodiment, the system 100 includes a communications satellite 102 which receives signals carrying data packets with synchronization signals through uplink channels and transmits the data packets through downlink channels.

The system 100 also includes one or more ground stations 104 and 106. The station 104 can be carried on ships, vehicles, planes and or embedded in transportable terminals. The station 104, which is a remote side, can be a stationary site, such as an antenna tower site for LMRS or cell phone or can be temporarily deployed in the field such as the area affected by natural disasters or emergency, where the land-based communications are unreliable, or in the public events, where no land-based networks are available. The station 106, which is a master site, is typically installed at a location outside of the disaster-affected area or in the home location of the organization providing the rescue mission or organizing the event.

Each of stations 104 and 106 includes an antenna 110 for communication with nearby stations or local network system. In one embodiment, the antenna 110 supports LMRS communications. In other embodiments, the antenna 110 can support cellular communications or wireless networking such as WiFi, 3G, or WiMax technologies.

Each of stations 104 and 106 further includes a Very Small Aperture Terminal (VSAT) with a dish antenna 112 or 114. In one embodiment, the dish antennae 112 and 114 have substantially identical size between 1 to 3 meters. In another embodiment as depicted in FIG. 1, the dish antenna 114 of the master station 106 is larger than the antenna 112 installed in the remote station 104.

As further shown in FIG. 1, ground stations 104 and 106 include additional components for providing telecommunications and networking services. In particular, the master station 106 includes, PolyPhaser 116, Block Upconverter (BUC), Phase-Locked Loop, Low Noise Block Downconverter (PLL LNB) 118, land-based network router 120 (e.g., T-1 Backhaul Router), failover device 132 (IPTUBE DLT-1), satellite network modem/router 124 (e.g., SkyEdge 2 Modem/Router with Mesh Card), and connection interface 126 (e.g., T-1 landline interface) to external networks.

Similarly, remote station 104 includes PolyPhaser 116, Block Upconverter (BUC), Phase-Locked Loop, Low Noise Block Downconverter (PLL LNB) 118, land-based network router 120 (e.g., T-1 Backhaul Router), failover device 132 (IPTUBE DLT-1), satellite network modem/router 124 (e.g., SkyEdge 2 Modem/Router with Mesh Card), and connection interface 126 (e.g., T-1 landline interface) to external networks. Remote station 104 further includes user application equipments such as Voice-over-IP equipment 128 and computer 130 for providing application level services including voice call, video conference, internet access, etc.

Ground stations 104 and 106 and satellite 102 forms a satellite-based mesh network. Each ground station can be connected to other ground stations through land-based networks (T-1 landline), exiting LMRS, as well as through satellite 102. Communications between satellite 102 and ground stations 104 and 106 are based on frequency-time division modulated access (FTDMA) signals in the Ku-Band, which are well known in the art.

In still a further embodiment, system 100 converges communications of voice, video and data, offering encryption capability such as the accelerated Federal Information Processing Standard 140-2 encryption. System 100 can also support Cisco certified satellite networking solution, enabling seamless integration of common carrier lines and satellite communications.

As shown in FIG. 1, when the satellite-based mesh network is engaged through the failover devices 132, the communications between the land-based network router 120 at stations 104 and 106 are transmitted through a two-hop connection between the stations, thereby limiting the one-way delay to less than 700 millisecond (ms). For example, the data packets coming out from the station 104 are transmitted through uplink 134 to the satellite 102, which then forwards the data packets through downlink 136 to the station 106. The latency caused by each of the uplink and downlink is approximately 350 ms. Compared with conventional hub-and-spoke satellite network, where each data packet travels through at least four hops (two between a first station to the hub and two between the hub and a second station), the communication latency in system 100 is minimized.

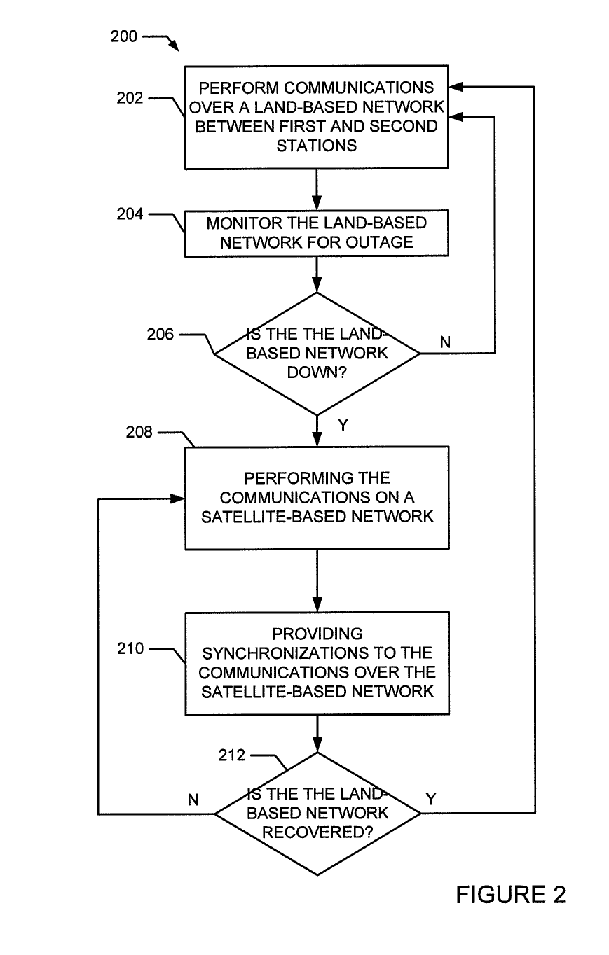

According to some alternative embodiments as shown in FIG. 2, a process 200, based on system 100, is provided for using a satellite-based mesh network to provide backup for land-based communications between two stations. The process 200 starts with step 202, where the communications between first and second stations (e.g., stations 104 and 106) are carried out through a land-based network (e.g., T-1 landline 126). These land-based communications required synchronizations between the first and second stations, which are provided by the T-1 signals carried by the T-1 landlines. In addition, the system 100 includes failover device 132, which monitors the land-based communications to detect the outage of the land-based network (steps 204 and 206).

When the land-based network is down due to network failure, the failover device 132 switches the communications onto a satellite-based network including the satellite 102 and the satellite-based network routers 124.

At step 210, the failover device 132 provides synchronizations to the communications over the satellite-based network. In particular, the failover devices 132 collect data from the land-based network routers 120 and convert them into data packets (e.g., IP packets) that are suitable for transmissions over the satellite-based mesh network. In addition, the failover device 132 incorporates synchronization signals (e.g., T-1 framing and synchronization bits) into the data packets. The data packets with the synchronization signals are then routed by the satellite-based network routers 124 between stations 104 and 106 through the satellite-based mesh network. At the receiving end, the synchronization signals are extracted from the received data packets and used to provide synchronization operations for the received data.

The process 200 also include step 212, where the failover devices 132 detects that the land-based network is recovered from the network failure, and switches the communications back to the land-based network.

Land Mobile Radio with Satellite Backhaul

In one embodiment, system 100 is compatible with existing LMRS networks, such as Motorola's Astro 25. Accordingly, system 100 has the ability to provide seamless automatic backup for the T-1 landline that supports the Land Mobile Radio (LMR) system such as the Public Safety Access Points (PSAPs). System 100 based on satellite network provides a cost-effective and reliable backup to terrestrial links that keep LMRS systems connected and operational when the T-1 landline is down due to network disruptions.

In addition to providing a reliable backup solution, system 100 putting LMRS over satellite solves the entire communication requirement for both Local Area Network (LAN) and Wide Area Network (WAN) connectivity. In case of disasters or emergencies, first responders typically set up their LMRS infrastructure such as station 104 on-scene to support local communications. Using LMRS over satellite 102, the first responders can communicate from the disaster site (e.g., station 104) to their home station (e.g., station 106) or other designated facilities connected to system 100.

Legacy Interfaces that Require No Programming During an Emergency

According to another embodiment, satellite network system 100 is IP based and is provided with an automatic interface to LRMS networks such as the Motorola Astro 25 network that rely on T-1 landlines or other terrestrially based T-1 circuits for backhaul of communications traffic.

In particular, both ends of the existing LMRS networks are designed to communicate for trunking the sites data over local T1 lines. So every remote tower site 104 and every master site 106 of the LMRS networks is set up for this serial communication link. All of the LMRS remote tower sites 104 are generally equipped with a T-1 Backhaul Router (i.e., land-based network router 120) which may include an interface card (e.g., Channel Service Unit card) to accept a T1 connection 126 provided by the local phone company. These T-1 Backhaul Routers can be manually configured to accommodate changes in the T-1 Landlines, (e.g. a change in the circuit's capacity) or even to use satellite circuits in lieu of a T-1 Landline. However, these changes require direct access to the T-1 Backhaul Router 120. The person who maintains the LMRS network (typically the equipment vendor) provides and maintains the authentication codes for the T-1 Backhaul Router. The authentication codes are needed to access the T-1 Backhaul Router 120 for reconfiguration. Individuals with the authentication codes and technical expertise can manually reconfigure the T-1 Backhaul Router to use the satellite circuit, either online or through physical access to the T-1 Backhaul Router. The emergencies or disasters that disrupt T-1 Landlines also make it very difficult, if not impossible, for the technicians to reconfigure T-1 Backhaul Routers to communicate with each other by satellite.

System 100 as depicted in FIG. 1 provides an automatic interface (i.e., failover device 132), which the T-1 Backhaul Routers accept as a direct replacement for the T-1 landline, thereby allowing the T-1 Backhaul router 120 to continue its operations without making emergency changes to the networks topology when the line-based network is down. This interface allows system 100 to match the number of DS0's, framing, synchronization and other variables enabling the T-1 Backhaul Routers to communicate with each other using a mesh satellite circuit instantaneously and without manual configuration.

As a result, system 100 provides a rapid emergency restoration of T-1 trunking capability on a mobile basis or as a fixed asset waiting to be used. System 100 is also cost effective compared with proprietary systems that rely on specialized satellites.

System 100 utilizes satellite mesh capabilities to provide first responders greater flexibility to communicate with personnel in any location, with reduced latency for quicker response times and an overall improved user experience. By utilizing the satellite mesh network in system 100, the VSAT of the master station 106 can make direct connections with the associated remote stations 104 utilizing only one trip to the satellite 102, without having to go through a central hub 108. Similarly, every two remote stations 104 can also make direct connections through satellite 102. In this embodiment, a teleport (i.e., central hub 108) provides command and control of these direct transmissions for as long as they last, and then retires the mesh bandwidth back into a “pool” of bandwidth to be used by any other connections when needed. This technique keeps latency at a minimum and eliminates any need of terrestrial resources at the remote site and at the agencies headquarters.

### Mesh Satellite Network

Most existing VSAT satellite networks are designed around a “hub-and-spoke” architecture, where the “hub” or teleport controls and manages all transactions across the system. In the hub-and-spoke network, each ground station of the network is connected to the satellite, which is then connected to the “hub.” At the same time, the “hub” is the stepping off point for access to the internet or the land based telephone exchanges (PSTN).

However the “hub-and-spoke” configuration requires each agency/client operate its own satellite hub, which is expensive and technically complex. If an agency wishes to connect one remote site to another, or back to their main operation center, using a hub-and-spoke system, the data must travel from the remote via satellite to the “hub” or teleport, and then be transferred again via satellite to the destination. Each transmission requires two trips to the satellite, or double hops to space, adding substantial latency to the transmissions that many communication systems cannot tolerate.

Existing solutions to the problem rely on a land line (i.e., T1 line) connecting the “hub” or teleport to the agency's operation center, reducing the latency to one hop to space plus the much smaller delay associated with the T1 line. This configuration, although a good compromise to reduce latency, exposes the entire system to the risk of a collapse. If the “backhaul” T1 line is lost or disconnected from the teleport, all satellite based remote sites are unreachable by the agency.

Various embodiments described herein effectively eliminate the vulnerability to land-based communications using the satellite network. These embodiments utilize the transparent mesh capability that allow a remote ground station (i.e., satellite site) to communicate with the “hub” or teleport center, as well as directly with another ground station. In these embodiments. Internet or PSTN services can be provided at the “hub” while at the same time telephone, data, LMR, or other audio/video communications can be transmitted directly between the ground stations themselves.

According to these embodiments, the mesh switching is provided by modem 124 at the ground stations, working in conjunction with Mesh Hub equipment 140 at site 108, instead of the dedicated switching circuit onboard the space craft itself. These embodiments allows service provides to use the mesh switching technique on any standard communication satellite rather than depending on just a handful of special satellites that support space-based routing. The failover device 132 utilizes the mesh network to automatically provide a direct one-hop-to-satellite link to any services between two ground stations to replace any pre-existing communication links. This direct one-hop-to-satellite link can be a direct connection between field offices or a connection from a field location back to the agency's network operation center (NOC).

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for utilizing a satellite mesh circuit to provide backup connections for land-based communications, the method including:
Performing communications over a land-based network between first and second stations, wherein the communications require network synchronizations between the first and second stations;
detecting a network failure in the land-based network; and
automatically switching the communications to a satellite-based network, wherein the network synchronizations are provided by adding at the first and second stations synchronization signals to the communications over the satellite-based network.

2. The method of claim 1, wherein the communications include voice and data communications based on data packets transmitted between the first and second stations.

3. The method of claim 1, wherein the land-based network includes at least a T1 network.

4. The method of claim 2, wherein the satellite-based network is based on an Internet protocol,
switching the communications to a satellite-based network further including:
receiving the data packets from a land-based network router of the first station;
converting the data packets into IP packets;
incorporating the synchronization signals into the IP packets; and
transmitting the IP packets with the synchronization signals to the second station through the satellite-based network.

5. The method of claim 4, further including:
receiving through the satellite-based network the IP packets with the synchronization information from the first station;
extracting the synchronization signals from the IP packets; and
performing the synchronization between the first and second stations based on the synchronization signals.

6. The method of claim 4, further including:
receiving voice and data signals at a wireless tower connected to the first station; and
converting the voice and data signals to the data packets.

7. The method of claim 5, wherein the satellite-based network includes at least one satellite, and the IP packets with synchronization signals are transmitted to and from the at least one satellite through frequency-time division multiple access (FTDMA).

8. The method of claim 5, further including routing the IP packets with the synchronization signals from the first station to the second station in accordance with a routing table.

9. The method of claim 8, wherein the IP packets with the synchronization signals are routed from the first station to the second station through a two-hop connection including a first hop from the first station to the satellite and the second hop from the satellite to the second station.

10. The method of claim 1, further including
detecting that the land-based network is recovered; and
switching the communication from the satellite-based network back to the land-based network.

11. A system for utilizing a satellite mesh circuit to provide backup connections for land-base communications, the system including:
a failover device connected to a land-based network router for detecting a network failure in a synchronized land-based network that provides communications between the land-based network and a remote station, automatically switching the communication from the land-based network to a satellite-based network in response to the network failure in the synchronized land-based network, and providing synchronizations to the communication over the satellite-based network; and
a satellite-based network router connected to the failover device for routing the communications to and from the remote station through the satellite-based network.

12. The system of claim 11, wherein the synchronized land-based network is a T1 network and the satellite-based network is based on an Internet protocol.

13. The system of claim 11, wherein the land-based network router is connected to the land-based network through the failover device.

14. The system of claim 12, wherein the failover device further receives data packets from the land-based network router, converts the data packets to IP packets, incorporates synchronization signals into the IP packets, and transmits the IP packets with the synchronization signals to the satellite-based network router.

15. The system of claim 14, wherein the satellite-based network router further routes the IP packets to and from the remote station through the satellite-based network in accordance with a routing table.

16. The system of claim 15, wherein the satellite-based network includes at least one satellite for receiving the IP packets from the satellite-based network router and forwarding the IP packets to the remote station, wherein the IP packets are routed to the remote station through a two-hop connection including a first hop between the satellite and the satellite-based network router and a second hop between the satellite and the remote station.

17. The system of claim 11, wherein the satellite is a transparent satellite.

18. A method for utilizing a satellite mesh circuit to provide backup connections for land-based communications, the method including:
detecting a network failure in a synchronized land-based network providing communications between first and second land-based network routers that require synchronizations;
automatically switching communications to an IP-based satellite network; and
providing the synchronizations required by the first and second land-based network routers for the communications over the IP-based satellite network so that the first and second land-based network routers are unaware of the switching from the synchronized land-based network to the IP-based satellite network.

19. The method of claim 18, wherein the synchronized land-based network is a T1 network.

20. The method of claim 18, further including:
receiving data packets from the first land-based network router;
converting the data packets to IP packets;
incorporating synchronization signals to the IP packets;
sending the IP packets with synchronization signals to a satellite in the satellite-based network;
receiving the IP packets with synchronization signals from the satellite;
extracting the synchronization signals from the IP packets;
recovering the data packets from the IP packets;
performing synchronization on the recovered data packets in accordance with the synchronization signals; and
forwarding the synchronized data packets to the second land-based network router.

21. The method of claim 20, wherein the satellite-based network includes at least one satellite and the IP packets with synchronization information are transmitted from the first land-based network router to the second land-based network router through a two-hop satellite connection including a first hop between the first land-based network router to the satellite and a second hop between the satellite and the second land-based network router.
